(19) United States
(12) Patent Application Publication
(10) Pub. No.: US 2024/0025931 A1
(43) Pub. Date: Jan. 25, 2024

(54) Acylphosphine Oxide Photoinitiators and Applications Thereof

(71) Applicant: AGFA NV, Mortsel (BE)

(72) Inventor: Johan Loccufier, Mortsel (BE)

(73) Assignee: AGFA NV, Mortsel (BE)

(21) Appl. No.: 18/253,238

(22) PCT Filed: Sep. 23, 2021
(86) PCT No.: PCT/EP2021/076148

§ 371 Date: May 17, 2023

(30) Foreign Application Priority Data
Nov. 19, 2020 (EP) 20208690.6

(51) Int. Cl. C07F 9/53; C09D 11/101; C09D 11/38

(52) U.S. Cl. CPC C07F 9/5337; C09D 11/101; C09D 11/38

(57) ABSTRACT

An acyl phosphine oxide initiator including an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group, wherein the urea group and the oxalylamide group include a tertiary amine group positioning a phosphorus atom of the acylphosphine oxide initiator in a 1 to Z position, where position 1 is defined as that of the phosphorus atom and position Z is defined as the nitrogen atom of the tertiary amine group with Z representing an integer of at least 11; and that the acyl phosphine oxide initiator contains no more than two photoinitiating moieties having a phosphine oxide group.

### TECHNICAL FIELD

The present invention relates to acyl phosphine oxide photoinitiators, optimized for surface cure in LED curing of UV curable compositions.

### BACKGROUND ART

In radiation curable technology, LED curing is becoming ever more important. Specifically, bathochromic LED's having an emitting wavelength between 365 nm and 400 nm are the work horses in state of the art curing technology, requiring specific initiators in comparison to the classical mercury bulbs. Acyl phosphine oxides are a preferred class of photoinitiators for LED curing.

Standard acyl phosphine oxides are not functionalized on the mesityl group, leading to the formation of volatile aldehydes upon curing and bad smell, making them less suitable for applications such as interior decoration. To solve this issue, a new class of acyl phosphine oxide initiators has been disclosed in WO 2019/243039 (AGFA NV).

Acyl phosphine oxide photoinitiators, including the acyl phosphine oxide photoinitiators disclosed in WO 2019/243039 (AGFA NV), are known to have limitations for surface cure, a problem that is even more pronounced when using LED curing. This leads to unacceptable physical properties and possible health risks caused by residual uncured monomers at the surface of the cured composition.

Therefore, there is a need for low odour acyl phosphine oxide having improved surface cure properties.

### SUMMARY OF INVENTION

In order to overcome the problems described above, preferred embodiments of the present invention have been realized with specific acyl phosphine oxide photoinitiators as defined in claim 1.

It was found that specific acyl phosphine oxide initiators substituted by a tertiary amine in a specific position in view of a phosphorus atom of the phosphine oxide group surprisingly exhibited improved surface cure properties, while still reducing bad odor.

Acyl phosphine oxide photoinitiators functionalized with high dipole self-complementary functional groups on the mesitaldehyde, selected from the group consisting of a urea group and an oxalyl amide group are particularly effective in reducing the odor of a cured UV curable composition. The figure here below illustrates how the volatile compounds are believed to interact leading to a reduction of bad odor.

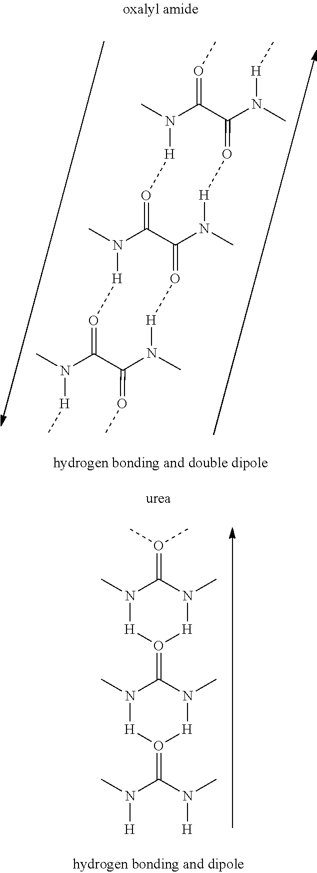

The size of polymeric and multifunctional photoinitiators has a significant impact on the reactivity of radiation curable compositions when cured under ambient atmosphere. Upon increasing molecular weight, oxygen inhibition is becoming more and more pronounced as diffusion of the initiating radical is slowing down in function of its molecular weight whereas oxygen keeps on diffusing very fast. In principle the problem can be solved by curing under inert atmosphere. However, an approach to cure under ambient conditions is highly preferred. For achieving an optimal balance between curing speed and migration properties, it was found that an acylphosphine oxide photoinitiator according to the present invention should not contain no more than two photoinitiating moieties having a phosphine oxide group, i.e. a monofunctional acylphosphine oxide photoinitiator, but preferably a difunctional acylphosphine oxide photoinitiator. The molecular weight of the acylphosphine oxide photoinitiator is preferably no more than 3000, more preferably no more than 2000 and most preferably no more than 1500.

It is an object of the present invention to provide a radiation curable composition comprising an acyl phosphine oxide initiator according to the present invention.

These and other objects will become apparent from the detailed description hereinafter.

### DESCRIPTION OF EMBODIMENTS

### Definitions

The term “multifunctional” in e.g. multifunctional acrylate means that the compound contains more than two acrylate groups.

The term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

Unless otherwise specified a substituted alkyl group, a substituted alkenyl group, a substituted alkynyl group, a substituted aralkyl group, a substituted alkaryl group, a substituted aryl and a substituted heteroaryl group are preferably substituted by one or more constituents selected from the group consisting of methyl, ethyl, n-propyl, isopropyl, n-butyl, isobutyl and tertiary-butyl, ester, amide, ether, thioether, ketone, aldehyde, sulfoxide, sulfone, sulfonate ester, sulphonamide, —Cl, —Br, —I, —OH, —SH, —CN and —NO₂.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted aralkyl group is preferably a phenyl or naphthyl group including one, two, three or more C₁ to C₆-alkyl groups.

Unless otherwise specified a substituted or unsubstituted alkaryl group is preferably a C₇ to C₂₅-alkyl group including a phenyl group or a naphthyl group.

A cyclic group includes at least one ring structure and may be a monocyclic- or polycyclic group, the latter meaning one or more rings fused together.

A heterocyclic group is a cyclic group that has atoms of at least two different elements as members of its ring(s). The counterparts of heterocyclic groups are homocyclic groups, the ring structures of which are made of carbon only. Unless otherwise specified a substituted or unsubstituted heterocyclic group is preferably a five- or six-membered ring substituted by one, two, three or four heteroatoms, preferably selected from oxygen atoms, nitrogen atoms, sulfur atoms, selenium atoms or combinations thereof.

An alicyclic group is a non-aromatic homocyclic group wherein the ring atoms consist of carbon atoms.

The term heteroaryl group means a monocyclic- or polycyclic aromatic ring comprising carbon atoms and one or more heteroatoms in the ring structure, preferably, 1 to 4 heteroatoms, independently selected from nitrogen, oxygen, selenium and sulphur. Preferred examples of heteroaryl groups include, but are not limited to, pyridinyl, pyridazinyl, pyrimidyl, pyrazyl, triazinyl, pyrrolyl, pyrazolyl, imidazolyl, (1,2,3,)- and (1,2,4)-triazolyl, pyrazinyl, pyrimidinyl, tetrazolyl, furyl, thienyl, isoxazolyl, thiazolyl, isoxazolyl, and oxazolyl. A heteroaryl group can be unsubstituted or substituted with one, two or more suitable substituents. Preferably, a heteroaryl group is a monocyclic ring, wherein the ring comprises 1 to 5 carbon atoms and 1 to 4 heteroatoms. More preferably a substituted or unsubstituted heteroaryl group is preferably a five- or six-membered ring substituted by one, two or three oxygen atoms, nitrogen atoms, sulphur atoms, selenium atoms or combinations thereof.

Unless otherwise specified an unsubstituted aryl group is preferably a phenyl group or naphthyl group.

Unless otherwise specified an acyl group is preferably a —C(═O)—R group wherein R is selected from the group consisting of an optionally substituted alkyl group, an optionally substituted aryl group, an optionally substituted heteroaryl group, an optionally substituted alkenyl group, an optionally substituted alkynyl group, an optionally substituted alkaryl group and an optionally substituted aralkyl group.

### Acylphosphineoxide Initiators

In a preferred embodiment of the invention, the photoinitiator is an acyl phosphine oxide initiator including an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group, wherein the urea group and the oxalylamide group include a tertiary amine group positioning an phosphorus atom of the acylphosphine oxide initiator in a 1 to Z position, where position 1 is defined as that of the phosphorus atom and position Z is defined as the nitrogen atom of the tertiary amine group with Z representing an integer of at least 11, preferably selected from 12 to 16; and that the acyl phosphine oxide initiator contains no more than two photoinitiating moieties having a phosphine oxide group.

The acyl phosphine oxide initiator is preferably substituted by an oxalylamide group as it was observed that such an initiator generally exhibits a better solubility in a wide range of monomers compared to its urea equivalent.

In a preferred embodiment, the acyl phosphine oxide initiator contains no thiol group if the acyl group includes an urea group. Thiol groups are often responsible for causing bad smell.

In a first embodiment, the acyl phosphine oxide initiator according to the invention is represented by formula I:

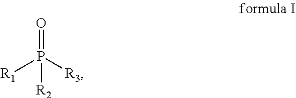

wherein R₁ represents a group according to formula II with the dotted line representing the point of attachment to the phosphorus atom in formula I:

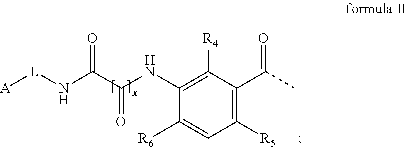

R₂ is selected from the group consisting of a substituted or unsubstituted aryl group, a substituted or unsubstituted heteroaryl group and OR₇; R₃ is selected from the group consisting of a substituted or unsubstituted aryl group, a substituted or unsubstituted heteroaryl group and an acyl group; R₄, R₅ and R₆ are independently selected from the group consisting of a hydrogen, a methyl group and a methoxy group; R₇ is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group; x represents an integer having a value of 0 or 1; L represents a divalent linking group having no more than 5 carbon atoms; and A represents an aliphatic tertiary amine group.

A substituent in the groups listed for R₇ may be a (meth)acryloyl group, preferably an acryloyl group.

In a preferred embodiment of the acyl phosphine oxide initiator, the acyl group R₃ is selected from the group consisting of a benzoyl group, a 2,6-dimethyl benzoyl group, a 2,6-dimethoxy benzoyl group, a 2,4,6-trimethyl benzoyl group and a 2,4,6-trimethoxybenzoyl group.

In a particularly preferred embodiment of the acyl phosphine oxide initiator, the acyl group R₃ represents a group R₁ according to formula II.

In a preferred embodiment of the acyl phosphine oxide initiator, the aliphatic tertiary amine group is substituted by alkyl groups independently from methyl, ethyl, propyl and butyl, preferably substituted by methyl or ethyl.

There is no limitation in the present invention to combine the above preferred embodiments.

In a second embodiment, the acyl phosphine oxide initiator according to the invention is represented by formula III:

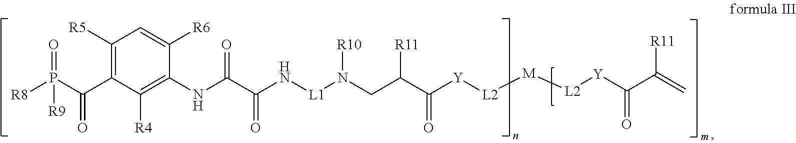

wherein
R4, R5 and R6 are independently selected from the group consisting of hydrogen, a methyl group and a methoxy group;
R8 is selected from the group consisting of a substituted or unsubstituted aryl group, a substituted or unsubstituted heteroaryl group and OR12;
R9 is selected from the group consisting of a substituted or unsubstituted aryl group, a substituted or unsubstituted heteroaryl group and an acyl group;
R10 represents a substituted or unsubstituted alkyl group;
R11 is selected from the group consisting of a hydrogen and a methyl group;
Y is selected from the group consisting of an oxygen and NR13;
R12 and R13 are independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group;
L1 represents a substituted or unsubstituted C₂ to C₆ alkylene group;
L2 represents a divalent linking group comprising no more than 10 carbon atoms;
n represents an integer 1 or 2;
m represents an integer from 0 to 3; and
M represents hydrogen if m=0; a covalent bond if n=m=1 or an n+m-valent moiety if n>1 and m>0.

In a preferred embodiment of the acyl phosphine oxide initiator, R9 is an acyl group selected from the group consisting of a benzoyl group, a 2,6-dimethyl benzoyl group, a 2,6-dimethoxy benzoyl group, a 2,4,6-trimethyl benzoyl group and a 2,4,6-trimethoxybenzoyl group.

In a preferred embodiment of the acyl phosphine oxide initiator, the n+m-valent moiety M is an aliphatic moiety comprising 1 to 10 carbon atoms, more preferably 1 to 6 carbon atoms and most preferably 1 to 4 carbon atoms.

In a preferred embodiment of the acyl phosphine oxide initiator, R4, R5 and R6 all represent a methyl group.

In a particularly preferred embodiment, R11 represent hydrogen and Y represents oxygen.

There is no limitation in the present invention to combine the above preferred embodiments.

A particularly preferred difunctional acylphosphine oxide photoinitiator is a compound according to Formula IV:

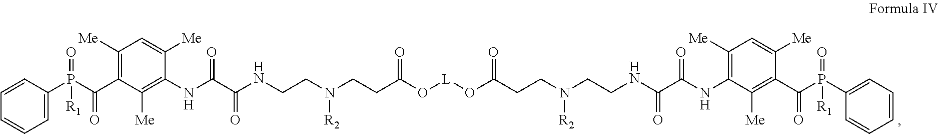

wherein

Particularly preferred acyl phosphine oxide photoinitiators according to the present invention are given below in Table 1 without being limited thereto.

TABLE 1

| | |
|---|---|
| APO-1 | 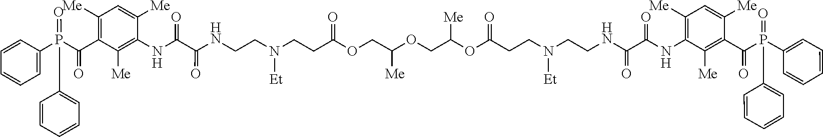 [SMILES: CCN(CCNC(=O)C(=O)Nc1c(C)cc(C)c(C(=O)P(=O)(c2ccccc2)c2ccccc2)c1C)CCC(=O)OCC(C)OCC(C)OC(=O)CCN(CC)CCNC(=O)C(=O)Nc1c(C)cc(C)c(C(=O)P(=O)(c2ccccc2)c2ccccc2)c1C] |
| APO-2 | 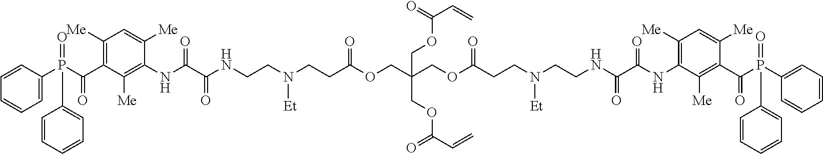 [SMILES: C=CC(=O)OCC(COC(=O)C=C)(COC(=O)CCN(CC)CCNC(=O)C(=O)Nc1c(C)cc(C)c(C(=O)P(=O)(c2ccccc2)c2ccccc2)c1C)COC(=O)CCN(CC)CCNC(=O)C(=O)Nc1c(C)cc(C)c(C(=O)P(=O)(c2ccccc2)c2ccccc2)c1C] |
| APO-3 | 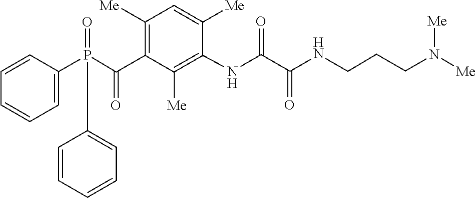 [SMILES: Cc1cc(C)c(C(=O)P(=O)(c2ccccc2)c2ccccc2)c(C)c1NC(=O)C(=O)NCCCN(C)C] |
| APO-4 | 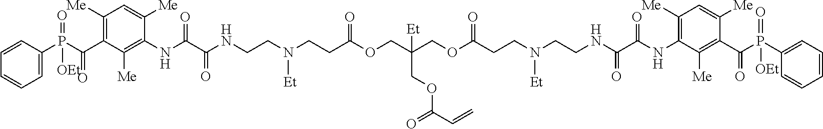 [SMILES: C=CC(=O)OCC(CC)(COC(=O)CCN(CC)CCNC(=O)C(=O)Nc1c(C)cc(C)c(C(=O)P(=O)(OCC)c2ccccc2)c1C)COC(=O)CCN(CC)CCNC(=O)C(=O)Nc1c(C)cc(C)c(C(=O)P(=O)(OCC)c2ccccc2)c1C] |
| APO-5 | 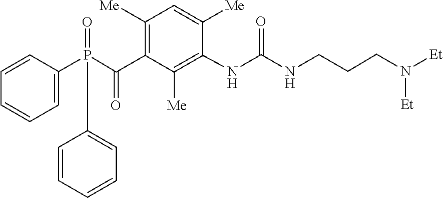 [SMILES: CCN(CC)CCCNC(=O)Nc1c(C)cc(C)c(C(=O)P(=O)(c2ccccc2)c2ccccc2)c1C] |
| APO-6 | 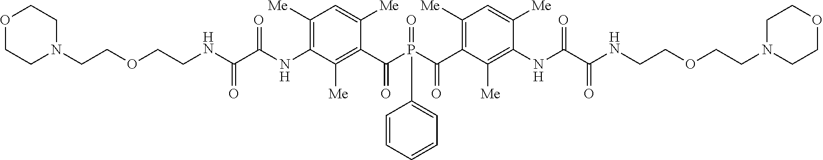 [SMILES: Cc1cc(C)c(C(=O)P(=O)(C(=O)c2c(C)cc(C)c(NC(=O)C(=O)NCCOCCN3CCOCC3)c2C)c2ccccc2)c(C)c1NC(=O)C(=O)NCCOCCN1CCOCC1] |
| APO-7 | 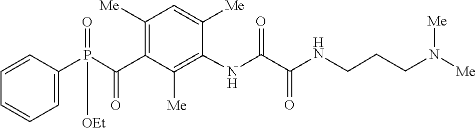 [SMILES: CCOP(=O)(C(=O)c1c(C)cc(C)c(NC(=O)C(=O)NCCCN(C)C)c1C)c1ccccc1] |
| APO-8 | 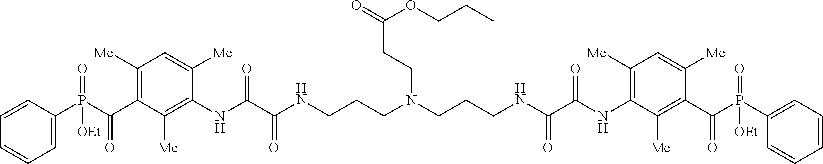 [SMILES: CCCOC(=O)CCN(CCCNC(=O)C(=O)Nc1c(C)cc(C)c(C(=O)P(=O)(OCC)c2ccccc2)c1C)CCCNC(=O)C(=O)Nc1c(C)cc(C)c(C(=O)P(=O)(OCC)c2ccccc2)c1C] |
| APO-9 | 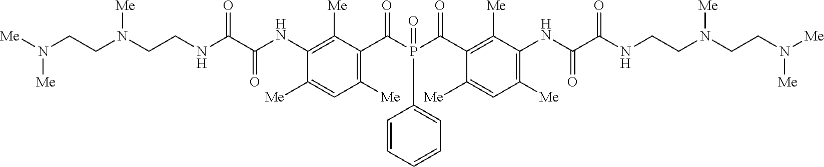 [SMILES: Cc1cc(C)c(C(=O)P(=O)(C(=O)c2c(C)cc(C)c(NC(=O)C(=O)NCCN(C)CCN(C)C)c2C)c2ccccc2)c(C)c1NC(=O)C(=O)NCCN(C)CCN(C)C] |
| APO-10 | 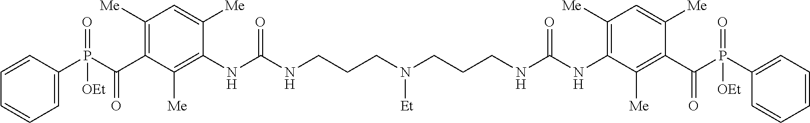 [SMILES: CCOP(=O)(C(=O)c1c(C)cc(C)c(NC(=O)NCCCN(CC)CCCNC(=O)Nc2c(C)cc(C)c(C(=O)P(=O)(OCC)c3ccccc3)c2C)c1C)c1ccccc1] |

### Synthesis Methods

The acyl phosphine oxide initiator of the second embodiment can be prepared from an intermediate represented by Formula IV:

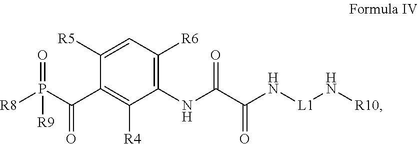

wherein
R4, R5 and R6 are independently selected from the group consisting of hydrogen, a methyl group and a methoxy group; R8 is selected from the group consisting of a substituted or unsubstituted aryl group, a substituted or unsubstituted heteroaryl group and OR12; R9 is selected from the group consisting of a substituted or unsubstituted aryl group, a substituted or unsubstituted heteroaryl group and an acyl group; R10 represents a substituted or unsubstituted alkyl group; R12 is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group; and L1 represents a substituted or unsubstituted C₂ to C₆ alkylene group.

The synthesis of the intermediate is executed by using a diamine of which one amine is a primary amine and the other amine is a secondary amine. By selecting such a diamine, it was surprisingly found that the aminolysis proceeded with 100% selectivity, thus allowing to selective produce tertiary amines on Michael-addition to e.g. acrylates. The synthesis of the intermediate is shown here below as the first step in the preparation an acyl phosphine oxide initiator in accordance with the invention. Alternatively, in order to obtain an acyl phosphine oxide initiator such as APO-3, APO-5 and APO-7 shown above, a diamine can be used of which one amine is a primary amine and the other amine is a tertiary amine.

A method for preparing an acyl phosphine oxide initiator in accordance with the second embodiment of the invention includes the steps:

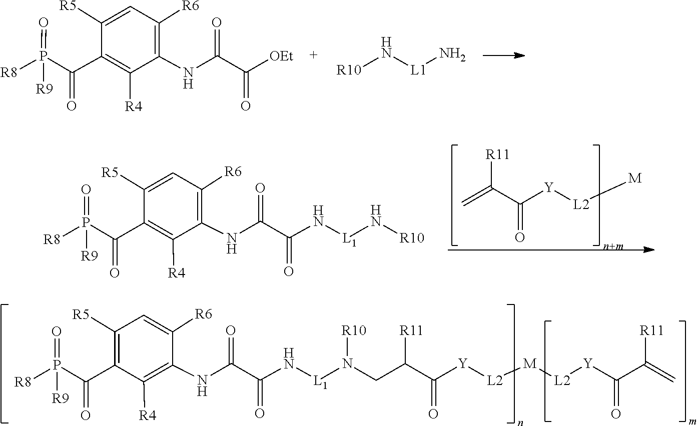

wherein
R4, R5 and R6 are independently selected from the group consisting of hydrogen, a methyl group and a methoxy group;
R8 is selected from the group consisting of a substituted or unsubstituted aryl group, a substituted or unsubstituted heteroaryl group and OR12;
R9 is selected from the group consisting of a substituted or unsubstituted aryl group, a substituted or unsubstituted heteroaryl group and an acyl group;
R10 represents a substituted or unsubstituted alkyl group;
R11 is selected from the group consisting of a hydrogen and a methyl group;
Y is selected from the group consisting of an oxygen and NR13;
R12 and R13 are independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group;
L1 represents a substituted or unsubstituted C₂ to C₆ alkylene group;
L2 represents a divalent linking group comprising no more than 10 carbon atoms;
n represents an integer 1 or 2;
m represents an integer from 0 to 3; and
M represents hydrogen if m=0; a covalent bond if n=m=1 or an n+m-valent moiety if n>1 and m>0.

In the second step of the above synthesis scheme, the intermediate reacts with a mono-, di- or multifunctional (meth)acrylate or a mono-, di- or multifunctional (meth)acrylamide, preferably with a mono-, di- or multifunctional (meth)acrylate and more preferably a mono-, di- or multifunctional acrylate.

In a further preferred embodiment, said mono-, di- or multifunctional acrylate or methacrylate is a di- or multifunctional acrylate or methacrylate, more preferably an acrylate and most preferably selected from the group consisting of poly(ethylene glycol) diacrylate, dipropylene glycol diacrylate, tripropylene glycol diacrylate, pentaerythritol triacrylate and ethoxylated or propoxylated derivatives thereof, trimethylol propane triacrylate and ethoxylated and propoxylated derivatives thereof, dipentaerythritol penta-acrylate and ethoxylated and propoxylated derivatives thereof, neopentyl glycol diacrylate and ethoxylated and propoxylated derivatives thereof, dipentaerythritol hexa-acrylate and ethoxylated and propoxylated derivatives thereof, glycerol triacrylate and ethoxylated and propoxylated derivatives thereof, ditrimethylolpropane tetraacrylate and ethoxylated and propoxylated derivatives thereof, hexamethylene diacrylate and ethoxylated and propoxylated derivatives thereof, neopentylglycol hydroxypivalate diacrylate, tricyclodecanedimethanol diacrylate and 3-methyl-1,5-pentanediyl diacrylate. Di-, tri- and tetrafunctional acrylates are particularly preferred.

In a preferred embodiment of the synthesis method, M represents an aliphatic moiety comprising 1 to 10 carbon atoms, more preferably 1 to 6 carbon atoms and most preferably 1 to 4 carbon atoms.

In a preferred embodiment, R9 is an acyl group selected from the group consisting of a benzoyl group, a 2,6-dimethyl benzoyl group, a 2,6-dimethoxy benzoyl group, a 2,4,6-trimethyl benzoyl group and a 2,4,6-trimethoxybenzoyl group.

In a preferred embodiment, the diamine represented by formula R10-NH-L1-NH₂ is selected from the group consisting of N-methyl-ethylene diamine, N-ethyl-ethylene diamine, N-isopropyl-ethylene diamine, N-butyl-ethylene diamine, caldopentamine, dimethyl-dipropylene diamine, N-methyl-1,3-propane diamine, N-ethyl-1,3-propane diamine, N-propyl-1,3-propane diamine, N-(2-methylpropyl)-1,3-propane diamine, N-octyl-1,3-propane diamine, spermidine, spermine, bis(3-aminopropyl) amine, N,N′-bis(3-aminopropyl)ethylene diamine, N-(2-hydroxyethyl)-1,3-propane-diamine, diethylene triamine, triethylene tetramine and tetraethylene pentamine.

A method for preparing an acyl phosphine oxide initiator according to the first embodiment including the steps:

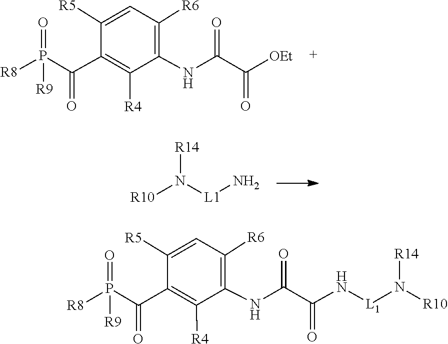

wherein
R4, R5 and R6 are independently selected from the group consisting of hydrogen, a methyl group and a methoxy group;
R8 is selected from the group consisting of a substituted or unsubstituted aryl group, a substituted or unsubstituted heteroaryl group and OR12;
R9 is selected from the group consisting of a substituted or unsubstituted aryl group, a substituted or unsubstituted heteroaryl group and an acyl group;
R10 and R14 independently represent a substituted or unsubstituted alkyl group;
R12 is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group; and
L1 represents a substituted or unsubstituted C₂ to C₆ alkylene group.

In a preferred embodiment of the synthesis method, R10 and R14 independently represent methyl or ethyl.

Difunctional photoinitiators, prepared according to the following synthesis scheme, are particularly preferred.

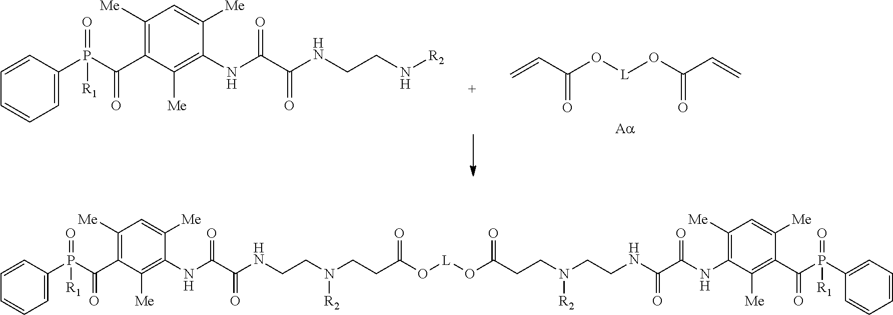

wherein R₁ represents OEt or phenyl; R₂ represents a C₁ to C₈ alkyl group; and L represents a divalent linking group having no more than 20 carbon atoms being not further functionalized with acrylates. In a preferred embodiment R₂ represents a C₁ to C₄ alkyl group, an ethyl and a methyl group being particularly preferred. The difunctional acrylate Acr used in the above synthesis is preferably selected from the compounds Acr-1 to Acr-15, without being limited thereto.

| | | |
|---|---|---|
| Acr-1 | Acr-2 | Acr-3 |
| Acr-4 | n = 4 on average | Acr-6 |
| | Acr-5 | |
| Acr-7 | Acr-8 | Acr-9 |
| Acr-10 | Acr-11 | Acr-12 |
| Acr-13 | Acr-14 | Acr-15 |

### Radiation Curable Compositions

A radiation curable composition in accordance with the invention comprises a free radical polymerizable compound and an acyl phosphine oxide initiator as described above.

Such radiation curable compositions may be employed in a wide range of applications. For instance, it can serve as a varnish for protecting a piece of furniture.

The radiation curable composition may also include a colorant, preferably a colour pigment. As such they can be used as a colored varnish or a printing ink for e.g. for flexography, intaglio printing or offset printing.

The acyl phosphine oxide initiator is preferably present in a radiation curable composition in an amount of 1 to 25 wt % based on the total weight of the radiation curable composition.

### Other Photoinitiators and Co-Initiators

In addition to the acyl phosphine oxide photoinitiator of the invention, the radiation curable composition may contain one or more other photoinitiators and/or co-initiators.

The other photoinitiator in the radiation curable composition is preferably a free radical initiator, more specifically a Norrish type I initiator or a Norrish type II initiator.

Preferred free radical photoinitiators are selected from the group consisting of polymerizable photoinitiators, polymeric photoinitiators and multifunctional photoinitiators.

Suitable photoinitiators are disclosed in CRIVELLO, J. V., et al. Photoinitiators for Free Radical Cationic and Anionic Photopolymerization. 2nd edition. Edited by BRADLEY, G. London, UK: John Wiley and Sons Ltd, 1998. p. 287-294.

An acyl phosphine oxide photoinitiator in accordance with the invention is preferably combined with a photoinitiator selected from the group consisting of a thioxanthone compound, an α-hydroxyalkylphenone compound and a carbazole compound. Such combinations allow to improve curing speed further.

A preferred combination of an acyl phosphine oxide photoinitiator in accordance with the invention is that with a second photoinitiator of the acyl phosphine oxide type for improving curability of a radiation curable composition.

In order to increase the photosensitivity further, the radiation curable composition may additionally contain co-initiators. Suitable examples of these co-initiators can be categorized in three groups: 1) tertiary aliphatic amines such as methyldiethanolamine, dimethylethanolamine, triethanolamine, triethylamine and N-methylmorpholine; (2) aromatic amines such as amylparadimethylaminobenzoate, 2-n-butoxyethyl-4-(dimethylamino) benzoate, 2-(dimethylamino)ethylbenzoate, ethyl-4-(dimethylamino)benzoate, and 2-ethylhexyl-4-(dimethylamino)benzoate; and (3) (meth)acrylated amines such as dialkylamino alkyl(meth)acrylates (e.g., diethylaminoethylacrylate) or N-morpholinoalkyl-(meth)acrylates (e.g., N-morpholinoethyl-acrylate). The preferred co-initiators are aminobenzoates. When one or more of these co-initiators are included into the radiation curable composition, health risks can be reduced.

A combination of a polymerizable co-initiator containing a tertiary amine and a polymeric co-initiator containing a tertiary amine may be advantageously used to adjust the viscosity of the radiation curable composition.

### Polymerizable Compounds

Any free radical polymerizable compound commonly known in the art may be employed. The polymerizable compound may be any monomer and/or oligomer found in the Polymer Handbook Vol 1+2, 4th edition, edited by J. BRANDRUP et al., Wiley-Interscience, 1999. An oligomer in the present invention is understood to contain 2 to 8 repeating monomeric units. Polymerizable polymers may also be used.

A monofunctional polymerizable compound is generally used for enhancing the flexibility of a cured layer, whereas a polyfunctional polymerizable compound is used for enhancing scratch resistance of the cured layer.

A monofunctional polymerizable compound contains a single polymerizable group, preferably a free radical polymerizable group selected from the group consisting of an acrylate, a methacrylate, an acrylamide, a methacrylamide, a styrene group, a maleate, a fumarate, an itaconate, a vinyl ether, a vinyl ester, an allyl ether and an allyl ester.

A polyfunctional polymerizable compound contains two, three or more polymerizable groups, preferably free radical polymerizable groups selected from the group consisting of an acrylate, a methacrylate, an acrylamide, a methacrylamide, a styrene group, a maleate, a fumarate, an itaconate, a vinyl ether, a vinyl ester, an allyl ether and an allyl ester.

### Colorants

The radiation curable composition may contain a colorant. The colorants may be dyes, pigments or a combination thereof. Organic and/or inorganic pigments may be used. The colorant is preferably a pigment or a polymeric dye, most preferably a colour pigment.

The pigments may be black, white, cyan, magenta, yellow, red, orange, violet, blue, green, brown, mixtures thereof, and the like. This colour pigment may be chosen from those disclosed by HERBST, Willy, et al. Industrial Organic Pigments, Production, Properties, Applications. 3rd edition. Wiley—VCH, 2004. ISBN 3527305769.

Generally, pigments are stabilized in the dispersion medium by dispersing agents, such as polymeric dispersants or surfactants. However, the surface of the pigments can also be modified to obtain so-called “self-dispersible” or “self-dispersing” pigments, i.e. pigments that are dispersible in the dispersion medium without dispersants.

### Polymerization Inhibitors

The radiation curable composition may contain a polymerization inhibitor. Suitable polymerization inhibitors include phenol type antioxidants, hindered amine light stabilizers, phosphor type antioxidants, hydroquinone monomethyl ether commonly used in (meth)acrylate monomers, and hydroquinone, t-butylcatechol, pyrogallol may also be used.

Suitable commercial inhibitors are, for example, Sumilizer™ GA-80, Sumilizer™ GM and Sumilizer™ GS produced by Sumitomo Chemical Co. Ltd.; Genorad™ 16, Genorad™ 18 and Genorad™ 20 from Rahn AG; Irgastab™ UV10 and Irgastab™ UV22, Tinuvin™ 460 and CGS20 from BASF; Floorstab™ UV range (UV-1, UV-2, UV-5 and UV-8) from Kromachem Ltd, Additol™ S range (S100, S110, S120 and S130) from Cytec Surface Specialties.

### Surfactants

The radiation curable composition may contain at least one surfactant for improving the spreading of the radiation curable composition. The surfactant can be anionic, cationic, non-ionic, or zwitter-ionic and is preferably added in a total quantity less than 3 wt % based on the total weight of the radiation curable composition.

Preferred surfactants are selected from fluoro surfactants (such as fluorinated hydrocarbons) and silicone surfactants. The silicone surfactants are preferably siloxanes and can be alkoxylated, polyester modified, polyether modified, polyether modified hydroxy functional, amine modified, epoxy modified and other modifications or combinations thereof. Preferred siloxanes are polymeric, for example polydimethylsiloxanes.

### EXAMPLES

### Materials

All materials used in the examples were readily available from standard sources such as Sigma-Aldrich (Belgium) and Acros (Belgium) unless otherwise specified. The water used is demineralized water.

Jeffamine™ EDR148 is a polyetheramine available from HUNTSMAN and represented by formula:

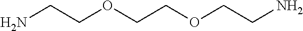

Jeffamine™ D400 is a polyetheramine with average molecular weight of about 430 available from HUNTSMAN and represented by formula:

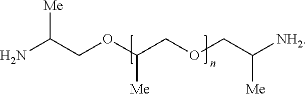

Jeffamine® T-403 is a polyetheramine available from HUNTSMAN and represented by formula:

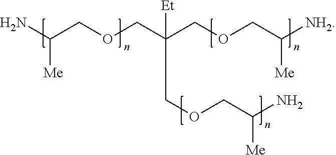

EDPP is ethyl 2-(3-diphenylphosphorylcarbonyl-2,4,6-trimethyl-anilino)-2-oxo-acetate and was synthesized in three steps as follows:

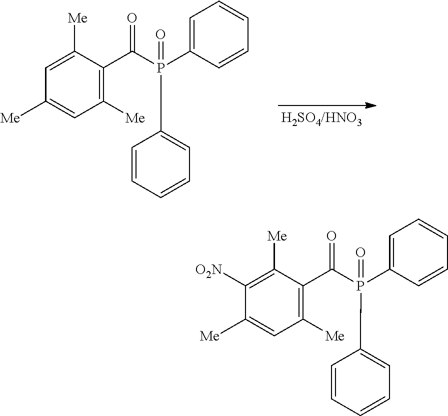 [SMILES: Cc1cc(C)c(C(=O)P(=O)(c2ccccc2)c2ccccc2)c(C)c1 ; Cc1cc(C)c([N+](=O)[O-])c(C)c1C(=O)P(=O)(c1ccccc1)c1ccccc1]

348.4 g (1 mol) (2,4,6-trimethylbenzoyl)diphenylphosphine oxide was added to 4847 g of a 65% HNO₃ solution while stirring. 337 g concentrated sulfuric acid was added dropwise over five and a half hours, while maintaining the reaction temperature below 32° C. The reaction was allowed to continue at room temperature for 20 hours. 1250 ml methylene chloride was added and the mixture was stirred for 10 minutes. The methylene chloride fraction was isolated an extracted twice with 2000 ml of a 10 w % solution of K₂HPO₄ in water. The methylene chloride fraction was isolated and extracted with 1250 ml brine. The methylene chloride fraction was isolated, dried over MgSO₄ and evaporated under reduced pressure. 500 ml n.-hexane was added and diphenylphosphoryl-(2,4,6-trimethyl-3-nitro-phenyl) methanone precipitated as pale yellow crystals. Diphenylphosphoryl-(2,4,6-trimethyl-3-nitro-phenyl) methanone was isolated by filtration and dried. 368 g (yield: 93%) of diphenylphosphoryl-(2,4,6-trimethyl-3-nitro-phenyl) methanone was isolated. (TLC analysis on TLC Silica Gel 60 F₂₅₄ supplied by Merck, eluent methylene chloride/ethyl acetate, R_{f}=0.69).

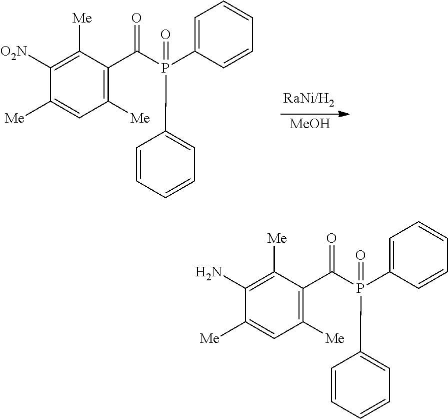 [SMILES: "MeOH" ; Cc1cc(C)c([N+](=O)[O-])c(C)c1C(=O)P(=O)(c1ccccc1)c1ccccc1 ; Cc1cc(C)c(C(=O)P(=O)(c2ccccc2)c2ccccc2)c(C)c1N]

123 g (0.31 mol) diphenylphosphoryl-(2,4,6-trimethyl-3-nitro-phenyl) methanone was dissolved in 1400 ml methanol. 6 g RaNi was washed three times with methanol and added to the solution and diphenylphosphoryl-(2,4,6-trimethyl-3-nitro-phenyl) methanone was hydrogenated at 40° C. at 50 bar hydrogen pressure. The reaction was allowed to continue at 40° C. for 8 hours. The RaNi was removed by filtration and 1300 ml methanol was evaporated under reduced pressure. 1000 ml methyl t.butyl ether was added to crystallize (3-amino-2,4,6-trimethyl-phenyl)-diphenylphosphoryl methanone. (3-amino-2,4,6-trimethyl-phenyl)-diphenylphosphoryl methanone was isolated by filtration washed with methyl t.butyl ether and dried. 96 g (yield: 85%) (3-amino-2,4,6-trimethyl-phenyl)-diphenylphosphoryl-methanone was isolated (TLC analysis on REV C18 plates, supplied by Büchi, eluent MeOH/1M NaCl 70/30: R_{f}: 0.2).

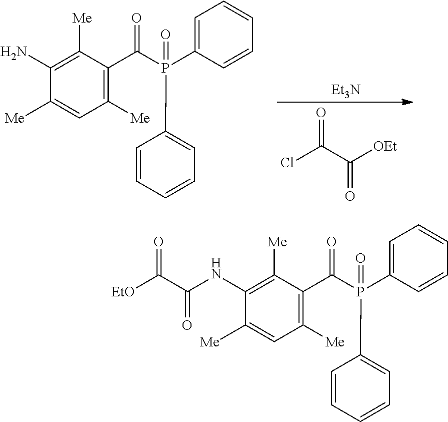

145.36 g (0.4 mol) (3-amino-2,4,6-trimethyl-phenyl)-diphenylphosphoryl methanone was dissolved in 600 ml methylene chloride. 40.89 g (0.4 mol) triethyl amine was added and the reaction mixture was cooled to −6.5° C. A solution of 61.24 g (0.44 mol) ethyl-oxalylchloride in 200 ml methylene chloride was added over one hour while keeping the reaction temperature below 0° C. The reaction was allowed to continue for two and a half hours, while the temperature gradually rose to 18° C. The precipitated triethyl amine hydrochloride was removed by filtration. The methylene chloride fraction was isolated and extracted with 1200 ml of a 20 wt % solution of K₂HPO₄ solution and 500 ml water. The methylene chloride fraction was isolated, dried over MgSO₄ and evaporated under reduced pressure to 300 ml. 1000 ml ethyl acetate was added to crystallize ethyl-2-(3-diphenylphosphorylcarbonyl-2,4,6-trimethyl-anilino)2-oxo-acetate (EDPP). EDPP was isolated by filtration, washed with ethyl acetate and dried. 168.4 g (yield: 91%) of EDPP was isolated (TLC analysis on TLC Silica Gel 60 F₂₅₄ supplied by Merck, eluent ethyl acetate/n.-hexane 70/30: R_{f}: 0.26).

APO-COMP-1 is an acylphosphine oxide initiator represented by formula:

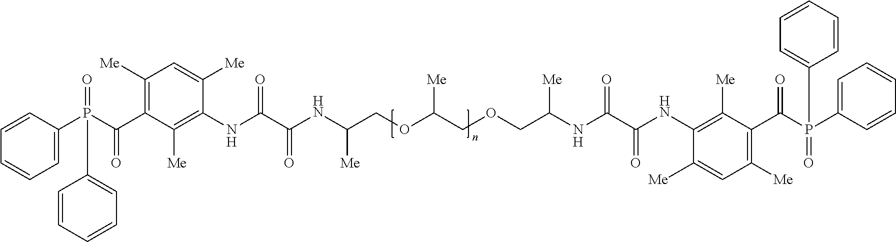

and was synthesized as follows:
2.50 g (5.4 mmol) EDPP was dissolved in 15 ml acetonitrile. 1.29 g Jeffamine™ D400 was added and the mixture was heated to reflux. The reaction was allowed to continue at reflux for 46 hours. After 46 hours, the solvent was removed by distillation and 0.13 g Jeffamine™ D400 in 2 ml acetonitrile was added. The reaction was allowed to continue at reflux for an additional 12 hours. The reaction mixture was allowed to cool down to room temperature. The residue was redissolved in 20 ml methylene chloride and the solvent was evaporated under reduced pressure. 2.7 g of APO-COMP-1 was isolated. The reaction was monitored by TLC chromatography until no EDPP was detectable anymore (TLC analysis on REV C18 plates supplied by Büchi, eluent: methanol/1 M NaCl 80/20).

APO-COMP-2 is initiator OXA-9, disclosed in WO 2019/243039 (AGFA), where n=1. APO-COMP-2 was synthesized as follows:

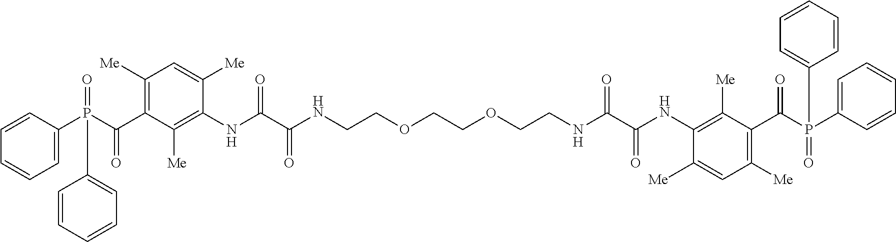 [SMILES: Cc1cc(C)c(C(=O)P(=O)(c2ccccc2)c2ccccc2)c(C)c1NC(=O)C(=O)NCCOCCOCCNC(=O)C(=O)Nc1c(C)cc(C)c(C(=O)P(=O)(c2ccccc2)c2ccccc2)c1C]

59.3 g (0.128 mol) EDPP was dissolved in 65 ml acetonitrile. 12.60 g Jeffamine™ EDR148 was added and the reaction mixture was heated to 76° C. The reaction was allowed to continue for 16 hours at 76° C. An additional 50 ml acetonitrile was added and the reaction mixture was allowed to cool down to room temperature. The solvent was removed under reduced pressure. 61.1 g of APO-COMP-2 was isolated. APO-COMP-2 was analyzed with TLC-MS (TLC analysis on REV C18 plates supplied by Büchi, eluent: methanol/1 M NaCl 80/20, Rf: 0.25). A minor compound in the mixture was identified as the mono-acylated structure (R_{f}: 0.62).

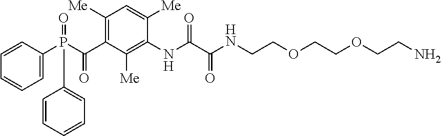 [SMILES: Cc1cc(C)c(C(=O)P(=O)(c2ccccc2)c2ccccc2)c(C)c1NC(=O)C(=O)NCCOCCOCCN]

APO-COMP-2 was used without further purification.

APO-COMP-3 is an acylphosphine oxide initiator represented by formula: and was synthesized as follows:

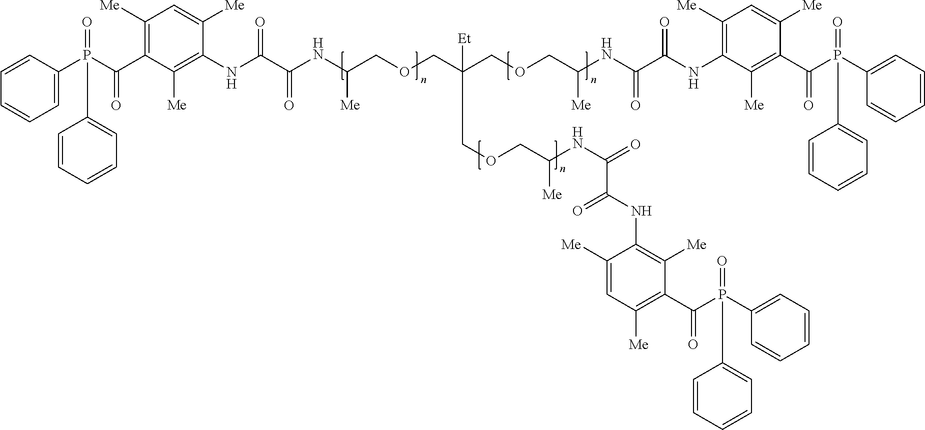

59.3 g (0.128 mol) EDPP was dissolved in 65 ml acetonitrile. 25.4 g Jeffamine™ T-403 was added and the mixture was heated to 76° C. The reaction was allowed to continue 22 hours at 76° C. The reaction mixture was allowed to cool down to 50° C. and the solvent was removed under reduced pressure. 71 g (yield: 85%) of APO-COMP-3 was isolated. The reaction was monitored by TLC chromatography until no EDPP was detectable anymore (TLC analysis on REV C18 plates supplied by Büchi, eluent: methanol/1 M NaCl 80/20).

Thioxanthon-1 is a 50 wt % solution in VEEA of a polymerizable thioxanthone having the chemical structure TX-1:

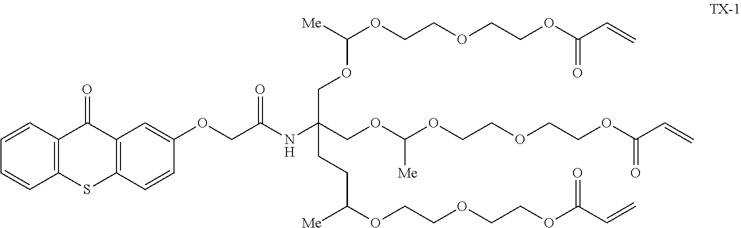 [SMILES: C=CC(=O)OCCOCCOC(C)CCC(COC(C)OCCOCCOC(=O)C=C)(COC(C)OCCOCCOC(=O)C=C)NC(=O)COc1ccc2sc3ccccc3c(=O)c2c1]

Thioxanthon-1 was prepared according to Example 1 of EP 2684876 A (AGFA).

BHT is butylated hydroxytoluene.

VEEA is 2-(2′-vinyloxyethoxy)ethyl acrylate, a difunctional monomer available from NIPPON SHOKUBAI, Japan.

PETA is pentaerythritol tetra-acrylate available as Sartomer™ 295 from ARKEMA.

DPGDA is dipropyleneglycoldiacrylate available as Laromer™ DPGDA from BASF.

CYAN is a copper phtalocyanine pigment (PB15:4), supplied by Sun Chemical Corporation as SUNFAST BLUE 15:4.

YELLOW is a PY150, supplied by BASF as Cromophtal Yellow D1085.

MAGENTA is a PV19, supplied by Clariant as Inkjet Magenta ESB02.

D162 is a solvent free version of Disperbyk 162, supplied by BYK Chemie GMBH, prepared by precipitation with iso-octane.

EFKA7701 is a polymeric dispersing agent supplied by BASF.

PET175 is a 175 μm thick unsubbed polyethylene terephthalate sheet available as Astera™ type UR1 75.344 from Agfa-Gevaert N.V.

INHIB is a mixture forming a polymerization inhibitor having a composition according to Table 2.

TABLE 2

| wt % of component: | INHIB |
|---|---|
| VEEA | 82.4 |
| p-methoxyphenol | 4.0 |
| Butylated hydroxytoluene (BHT) | 10.0 |
| Cupferron ™ Al | 3.6 |

Cupferron™ AJ is aluminum N-nitrosophenylhydroxylamine from WAKO Chemicals LTD.

BYK333 is a polyether-modified polydimethylsiloxane surfactant Byk™-333 from BYK ALTANA GROUP.

### Measurement Methods

### 1. TLC-MS Analysis:

The molecular mass was determined using TLC-MS, according to the following procedure. A TLC was run under circumstances given in the synthetic examples. The TLC was analyzed using a CAMAG™ TLC-MS interface coupled to an AmaZon™ SL mass spectrometer (supplied by Bruker Daltonics) via an Agilent™ 1100 HPLC pump. First a blank spectrum was taken by eluting a spot on the TLC plate where no compounds are present with a 0.01 molar solution of ammonium acetate in methanol. A second spectrum of the compound to be analyzed was taken by eluting the spot of the compound under consideration with a 0.01 molar solution of ammonium acetate in methanol. The first spectrum was subtracted from the second spectrum, giving the spectrum of the compound to be analyzed.

### 2. Surface Cure

The surface cure was evaluated by wiping with a Q-tip and was scored from KO to K5, where KO no visual damage on the surface to K5, which shows a complete removal of the coating. K3 means clear surface damage of the coating, which remains tacky, with only partly removal of the coating from the surface of the substrate.

### Example 1

This example illustrates the synthesis of acylphosphine oxide initiators according to the first embodiment wherein a diamine is used containing a primary amine and a tertiary amine.

### Synthesis of N-[3-(dimethylamino)propyl]-N′-(3-diphenylphosphorylcarbonl2,4,6-trimethyl-phenyl)oxamide (APO-3)

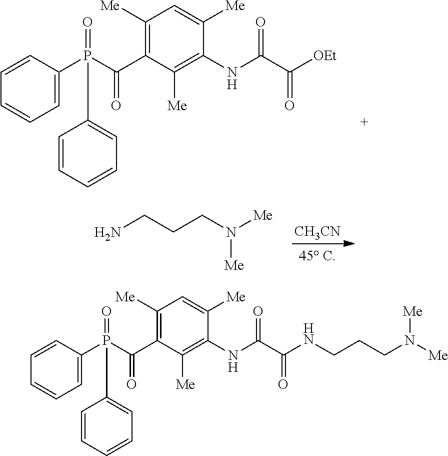

2.78 g (6 mmol) EDPP was dissolved in 15 ml acetonitrile. 0.619 g (6 mmol) 3-dimethylamino-propyl amine was added and the reaction mixture was heated to 43° C. The reaction was allowed to continue at 43° C. for 6 hours. The reaction mixture was allowed to cool down to room temperature and the solvent was removed under reduced pressure. 3 g (yield: 96%) of APO-3 was isolated (TLC analysis on REV C18 plates supplied by Büchi, eluent: methanol/1 M NaCl: 70/30, R_{f}:0.32). The structure was confirmed by TLC-MS.

### Example 2

This example illustrates the synthesis of acylphosphine oxide initiators according to the second embodiment wherein a diamine is used containing a primary amine and a secondary amine.

### Synthesis of N′-(3-diphenylphosphorylcarbonyl-2,4,6-trimethyl-phenyl)N-[2-(ethylamino)ethyl]oxamide

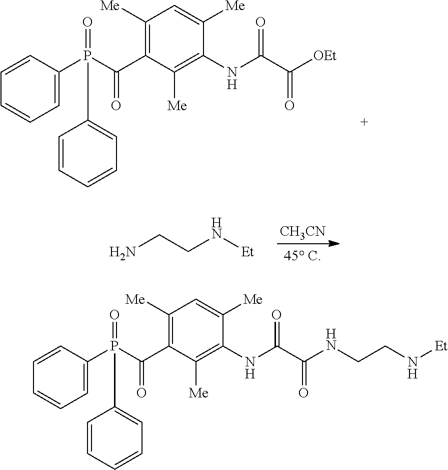

2.78 g (6 mmol) EDPP was dissolved in 15 ml acetonitrile. 0.534 g (6 mmol) N-ethyl-ethylene diamine was added and the reaction mixture was heated to 45° C. The reaction was allowed to continue for six and a half hours at 45° C. The reaction mixture was allowed to cool down to room temperature. A small precipitated residue was removed by filtration and the solvent was removed under reduced pressure. 2.8 g (yield: 92%) of N′-(3-diphenylphosphorylcarbonyl-2,4,6-trimethyl-phenyl)-N-[2-(ethylamino)ethyl]oxamide was isolated. (TLC analysis on REV C18 plates supplied by Büchi, eluent: methanol/1 M NaCl: 70/30, R_{f}: 0.42). The structure was confirmed by TLC-MS.

### Synthesis of APO-1

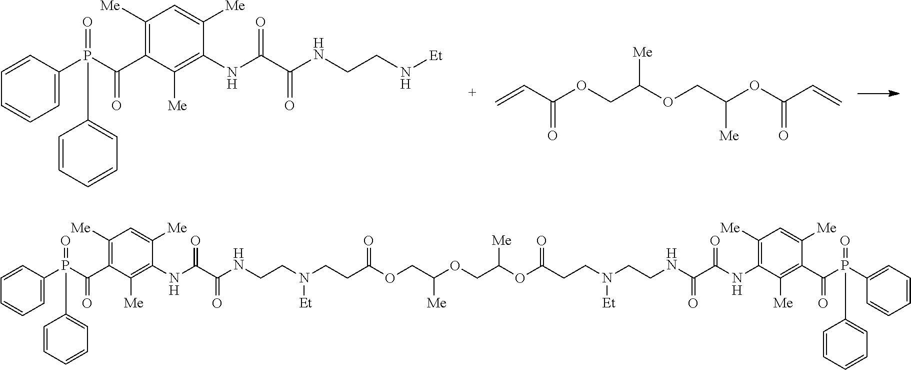 [SMILES: CCNCCNC(=O)C(=O)Nc1c(C)cc(C)c(C(=O)P(=O)(c2ccccc2)c2ccccc2)c1C ; C=CC(=O)OCC(C)OCC(C)OC(=O)C=C ; CCN(CCNC(=O)C(=O)Nc1c(C)cc(C)c(C(=O)P(=O)(c2ccccc2)c2ccccc2)c1C)CCC(=O)OCC(C)OCC(C)OC(=O)CCN(CC)CCNC(=O)C(=O)Nc1c(C)cc(C)c(C(=O)P(=O)(c2ccccc2)c2ccccc2)c1C]

1 g (1.98 mmol) N′-(3-diphenylphosphorylcarbonyl-2,4,6-trimethyl-phenyl)-N-[2-(ethylamino)ethyl]oxamide was dissolved in 5 ml dimethyl acetamide. 5 mg BHT was added, followed by the addition of 0.252 g (1.04 mmol) DPGDA. The reaction mixture was heated to 85° C. and the reaction was allowed to continue for 43 hours at 85° C. The reaction mixture was allowed to cool down to room temperature and 25 ml water was added. The crude APO-1 precipitated as an oil. Water was removed and the residue was redissolved in 25 ml methylene chloride. The mixture was extracted twice with 25 ml water. The organic fraction was isolated, dried over MgSO₄ and evaporated under reduced pressure. 1.24 g of the crude APO-1 was isolated. The crude APO-1 was purified by preparative column chromatography on a Prochrom LC 80 column, using Kromasil C18 100A 10 μm as stationary phase and methanol/0.2 M ammonium acetate as eluent. 0.38 g of APO-1 was isolated (TLC analysis on REV C18 plates supplied by Büchi, eluent: methanol/1 M NaCl: 70/30, R_{f}: 0.2). The structure was confirmed by TLC-MS.

### Synthesis of APO-2

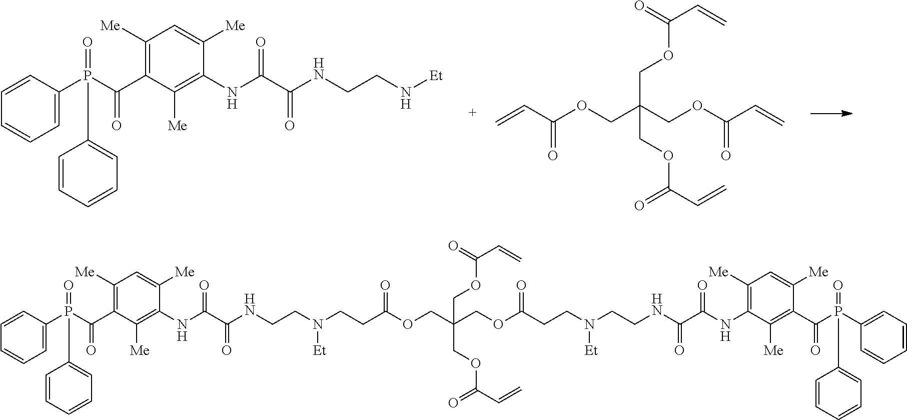 [SMILES: CCNCCNC(=O)C(=O)Nc1c(C)cc(C)c(C(=O)P(=O)(c2ccccc2)c2ccccc2)c1C ; C=CC(=O)OCC(COC(=O)C=C)(COC(=O)C=C)COC(=O)C=C ; C=CC(=O)OCC(COC(=O)C=C)(COC(=O)CCN(CC)CCNC(=O)C(=O)Nc1c(C)cc(C)c(C(=O)P(=O)(c2ccccc2)c2ccccc2)c1C)COC(=O)CCN(CC)CCNC(=O)C(=O)Nc1c(C)cc(C)c(C(=O)P(=O)(c2ccccc2)c2ccccc2)c1C]

1.57 g (1.55 mmol) N′-(3-diphenylphosphorylcarbonyl2,4,6-trimethyl-phenyl)-N-[2-(ethylamino)ethyl]oxamide was dissolved in 5 ml dimethyl acetamide. 8 mg BHT was added followed by the addition of 0.505 g PETA. The reaction mixture was heated to 75° C. and the reaction was allowed to continue for 16 hours at 75° C. The reaction mixture was allowed to cool down to room temperature and poured into 25 ml water. The crude APO-2 precipitated as an oil. The aqueous phase was removed and the residue was dissolved in 25 ml methylene chloride. The organic fraction was extracted twice with 25 ml water. The organic fraction was isolated, dried over MgSO₄ and evaporated under reduced pressure. 1.62 g (yield: 74%) of APO-2 was isolated. The reaction was monitored with TLC chromatography until N′-(3-diphenylphosphorylcarbonyl2,4,6-trimethyl-phenyl)-N-[2-(ethylamino) ethyl]oxamide was no longer detectable (TLC analysis on REV C18 plates supplied by Büchi, eluent: methanol/1 M NaCl 70/30).

### Example 3

Two difunctional photoinitiators APO-1 and APO-COMP-1 having a similar molecular weight and strong chemical resemblance are compared in this example for curing speed and surface cure.

### Preparation of Radiation Curable Compositions

The inventive radiation curable composition INV-1 and the comparative radiation curable composition COMP-1 were prepared according to Table 3. The weight % (wt %) are based on the total weight of the radiation curable compositions. Compounds APO-1 and APO-COMP-1 were present in equal molar amounts in the radiation curable compositions.

TABLE 3

| wt % of: | INV-1 | COMP-1 |
|---|---|---|
| VEEA | 90.0 | 89.7 |
| APO-1 | 10.0 | — |
| APO-COMP-1 | — | 10.3 |

### Evaluation and Results

The inventive radiation curable composition INV-1 and comparative radiation curable composition COMP-1 were coated on an unsubbed PET using a 20 μm wired bar. The formulations were cured using a Fusion DRSE-120 conveyer equipped with 12 W 395 nm LED at a speed of 20 m/min. The number of passes needed to obtain a full surface cure were determined, with a maximum of 10 passes. The results are summarized in Table 4.

TABLE 4

| | Number | Surface |
|---|---|---|
| Cured sample | of passes | cure |
| INV-1 | 3 | K0 |
| COMP-1 | 10 | K3 |

From Table 4, it becomes apparent that the photoinitiator according to the present invention significantly improves the surface cure when curing under ambient atmosphere.

Both radiation curable compositions were also evaluated by curing in the absence of oxygen (nitrogen blanket). In the absence of oxygen both formulations were fully cured in one pass.

No bad smell was detected for the fully cured samples.

### Example 4

This example illustrates the good curing properties of acylphosphine oxide initiators in accordance with the invention.

### Preparation of Radiation Curable Compositions

The inventive radiation curable compositions INV-2 and INV-3 and the comparative radiation curable compositions COMP-2 and COMP-3 were prepared according to Table 5. The weight % (wt %) are based on the total weight of the radiation curable compositions.

TABLE 5

| wt % of : | INV-2 | INV-3 | COMP-2 | COMP-3 |
|---|---|---|---|---|
| VEEA | 89.2 | 91.8 | 92.2 | 91.6 |
| APO-2 | 10.8 | — | — | — |
| APO-3 | — | 8.2 | — | — |
| APO-COMP-2 | — | — | 7.8 | — |
| APO-COMP-3 | — | — | — | 8.4 |

### Evaluation and Results

The inventive radiation curable compositions INV-2 and INV-3 and comparative radiation curable composition COMP-2 and COMP-3 were coated on an unsubbed PET using a 20 μm wired bar. The radiation curable compositions were cured using a Fusion DRSE-120 conveyer equipped with 12 W 395 nm LED at a speed of 20 m/min. The number of passes needed to become a full surface cure were determined, with a maximum of 10 passes. The results are summarized in Table 6.

TABLE 6

| | Number | Surface |
|---|---|---|
| Sample | of passes | cure |
| INV-2 | 4 | K0 |
| INV-3 | 4 | K0 |
| COMP-2 | 10 | K3 |
| COMP-3 | 10 | K4 |

From Table 6, it should be clear that only the photoinitiators according to the present invention give sufficient surface cure upon LED exposure. Formulations based on the comparative photoinitiators remained tacky even after 10 passes. No bad odor was observed for the samples INV-2 and INV-3.

### Example 5

This example illustrates the efficiency in avoiding oxygen inhibition upon UV LED curing for a CMY inkjet ink set B wherein the inkjet inks contain an acylphosphine oxide initiator in accordance with the invention.

### Preparation of Concentrated Pigment Dispersions

### Preparation of the Cyan Pigment Dispersion DISP-C

A concentrated cyan pigment dispersion DISP-C was prepared having a composition according to Table 7.

TABLE 7

| wt % of component: | DISP-C |
|---|---|
| CYAN | 15 |
| EFKA 7701 | 10 |
| INHIB | 1 |
| VEEA | 37.5 |
| DPGDA | 36.5 |

A Dynomill™ ECM multilab, filled with 1.285 kg of 0.4 mm yttrium stabilized zirconia beads (“high wear resistant zirconia grinding media” from TOSOH Co.), was preloaded with 0.335 kg DPGDA.

0.317 kg DPGDA, 0.375 kg of a 40 wt % solution of EFKA7701 in DPGDA, 23 g of INHIB and 0.45 kg CYAN were mixed, using a DISPERLUX™ dispenser. Stirring was continued for 30 minutes. The vessel was connected to the Dynomill™ ECM multilab and milling was continued for two hours while circulating at 0.2 liter per minute and with a rotation speed of 10 m/s. After two hours 0.375 kg of a 40 wt % solution of EFKA7701 in DPGDA and 1.125 kg VEEA were added to the vessel and circulation was continued. During the milling process, the mill was cooled to keep the temperature below 60° C. After milling, the dispersion was charged into a vessel. The average particle size was 98 nm with a viscosity of 91 mPa·s.

### Preparation of the Yellow Pigment Dispersion DISP-Y

A concentrated yellow pigment dispersion DISP-Y, was prepared having a composition according to Table 8.

TABLE 8

| wt % of component: | DISP-Y |
|---|---|
| YELLOW | 15 |
| D162 | 15 |
| INHIB | 1 |
| VEEA | 69 |

A Dynomill™ ECM AP2, filled with 4.788 kg of 0.4 mm yttrium stabilized zirconia beads (“high wear resistant zirconia grinding media” from TOSOH Co.), was preloaded with 2.49 kg VEEA.

0.15 kg VEEA, 3 kg of a 30 wt % solution of D162 in VEEA, 60 g of INHIB and 1.8 kg YELLOW were mixed, using a DISPERLUX™ dispenser. Stirring was continued for 30 minutes. The vessel was connected to the Dynomill™ ECM AP-2 and milling was continued for three hours while circulating at 2 liter per minute and with a rotation speed of 13 m/s. After three hours 3 kg of a 30 wt % solution of D162 in VEEA and 3 kg VEEA were added to the vessel and circulation was continued. During the milling process, the mill was cooled to keep the temperature below 60° C. After milling, the dispersion was charged into a vessel. The average particle size was 128 nm with a viscosity of 99 mPa·s.

### Preparation of the Magenta Pigment Dispersion DISP-M

A concentrated magenta pigment dispersion DISP-M, was prepared having a composition according to Table 9.

TABLE 9

| wt % of component: | DISP-M |
|---|---|
| MAGENTA | 15 |
| EFKA 7701 | 10 |
| INHIB | 1 |
| VEEA | 25 |
| DPGDA | 49 |

A Dynomill™ ECM AP2, filled with 4.788 kg of 0.4 mm yttrium stabilized zirconia beads (“high wear resistant zirconia grinding media” from TOSO Co.), was preloaded with 2.49 kg DPGDA.

4.14 kg DPGDA, 1.275 kg EFKA7701, 170 g of INHIB and 2.55 kg MAGENTA were mixed, using a DISPERLUX™ dispenser. Stirring was continued for 30 minutes. The vessel was connected to the Dynomill™ ECM AP-2 and milling was continued for four and a half hours while circulating at 2 liter per minute and with a rotation speed of 13 m/s. After two hours 0.425 kg EFKA7701, 4.25 kg VEEA and 1.7 kg DPGDA were added to the vessel and circulation was continued. During the milling process, the mill was cooled to keep the temperature below 60° C. After milling, the dispersion was charged into a vessel. The average particle size was 113 nm with a viscosity of 107 mPa·s.

### Preparation Inkjet Ink Sets A and B

The comparative inkjet ink set A and the inventive inkjet inks set B were prepared by mixing the components in each ink according to Table 10. All weight percentages are based on the total weight of the inkjet ink.

TABLE 10

| wt % of | Inkjet Ink Set A | | | Inkjet Ink Set B | | |
|---|---|---|---|---|---|---|
| component: | Ink C | Ink M | Ink Y | Ink C | Ink M | Ink Y |
| DISP-C | 20 | | | 20 | | |
| DISP-M | | 20 | | | 20 | |
| DISP-Y | | | 20 | | | 20 |
| APO-COMP2 | 10 | 10 | 10 | | | |
| APO-1 | | | | 10 | 10 | 10 |
| Thioxanthon-1 | 20 | 20 | 20 | 20 | 20 | 20 |
| VEEA | 49 | 49 | 49 | 49 | 49 | 49 |
| INHIB | 1 | 1 | 1 | 1 | 1 | 1 |

### Evaluation and Results

Each inkjet ink was coated on PET175 using a 4 μm wired bar. The inks were then cured on a conveyer belt equipped with a 12 W 395 nm LED at a speed of 30 m/min. The number of passes required for a full surface cure was determined measured, with a maximum of 10 passes. The results are summarized in Table 11.

TABLE 11

| Inkjet | Inkjet | Number |
|---|---|---|
| Ink Set | ink | of passes |
| A | C | 4 |
| | M | 6 |
| | Y | 4 |
| B | C | 1 |
| | M | 2 |
| | Y | 2 |

From Table 1, it becomes apparent that the inkjet inks of ink set B containing an acylphosphine oxide initiator in accordance with the invention have a high LED sensitivity, independent of the type of pigment. Also no bad smell was detected for images printed with ink set B.

### Example 6

This example illustrates the jettability of an inkjet ink containing an acylphosphine oxide initiator in accordance with the invention.

### Preparation of the Inkjet Ink

The inkjet ink C-1 was prepared by mixing the components according to Table 12. All weight percentages are based on the total weight of the ink.

TABLE 12

| wt % of component: | Inkjet Ink C-1 |
|---|---|
| DISP-C | 20.0 |
| APO-1 | 10.0 |
| Thioxanthon-1 | 20.0 |
| VEEA | 48.9 |
| INHIB | 1.0 |
| BYK333 | 0.1 |

The inkjet ink C-1 was filtered over a 1.6 μm filter and the jettability was evaluated using a Dimatix™ DMP2831 system, equipped with a standard Dimatix™ 10 pl print head. The ink was jetted at 22 C, using a firing frequency of 5 kHz, a firing voltage of 25 V and a standard waveform. All nozzles started without the need for priming and kept on printing. A two by 10 cm patch was printed on an unsubbed 175 μm PET and cured using a conveyer belt at a speed of 30 m/min, equipped with a 12 W 395 nm LED. The ink spread well on the PET substrate and was fully cured after one pass.

1-15. (canceled)

16. An acyl phosphine oxide initiator including an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group,
wherein the urea group and the oxalylamide group include a tertiary amine group positioning a phosphorus atom of the acylphosphine oxide initiator in a 1 to Z position, where position 1 is defined as that of the phosphorus atom and position Z is defined as the nitrogen atom of the tertiary amine group with Z representing an integer of at least 11, and
wherein the acyl phosphine oxide initiator contains no more than two photoinitiating moieties having a phosphine oxide group.

17. The acyl phosphine oxide initiator of claim 16, where position 1 is defined as that of the phosphorus atom and position Z is defined as the nitrogen atom of the tertiary amine group with Z representing an integer selected from 12 to 16.

18. The acyl phosphine oxide initiator of claim 16, wherein the acyl phosphine oxide initiator is of formula I: 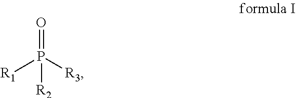
wherein
R₁ is a group according to formula II, with the dotted line representing the point of attachment to the phosphorus atom in formula I, 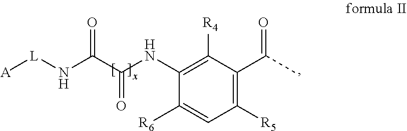
R₂ is selected from the group consisting of a substituted or unsubstituted aryl group, a substituted or unsubstituted heteroaryl group, and OR₇;
R₃ is selected from the group consisting of a substituted or unsubstituted aryl group, a substituted or unsubstituted heteroaryl group, and an acyl group;
R₄, R₅, and R₆ are each independently selected from the group consisting of hydrogen, a methyl group, and a methoxy group;
R₇ is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group;
x is an integer having a value of 0 or 1;
L is a divalent linking group having no more than 5 carbon atoms; and
A is an aliphatic tertiary amine.

19. The acyl phosphine oxide initiator of claim 18, wherein the acyl group R₃ is a group R₁ according to formula II.

20. The acyl phosphine oxide initiator of claim 18, wherein the aliphatic tertiary amine A is substituted by alkyl groups independently selected from methyl, ethyl, propyl, and butyl.

21. The acyl phosphine oxide initiator of claim 16, wherein the acyl phosphine oxide initiator is of formula III: 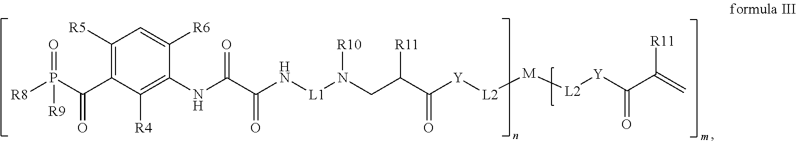
wherein
R4, R5, and R6 are each independently selected from the group consisting of hydrogen, a methyl group, and a methoxy group;
R8 is selected from the group consisting of a substituted or unsubstituted aryl group, a substituted or unsubstituted heteroaryl group, and OR12;
R9 is selected from the group consisting of a substituted or unsubstituted aryl group, a substituted or unsubstituted heteroaryl group, and an acyl group;
R10 is a substituted or unsubstituted alkyl group;
each R11 independently is selected from the group consisting of a hydrogen and a methyl group;
Y is selected from the group consisting of an oxygen and NR13;
R12 and R13 are each independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group;
L1 is a substituted or unsubstituted C₂ to C₆ alkylene group;
L2 is a divalent linking group comprising no more than 10 carbon atoms;
n is an integer 1 or 2;
m is an integer from 0 to 3; and
M is hydrogen if m=0; a covalent bond if n=m=1 or an n+m-valent moiety if n>1 and m>0.

22. The acyl phosphine oxide initiator of claim 21, wherein R9 is an acyl group selected from the group consisting of a benzoyl group, a 2,6-dimethyl benzoyl group, a 2,6-dimethoxy benzoyl group, a 2,4,6-trimethyl benzoyl group, and a 2,4,6-trimethoxybenzoyl group.

23. The acyl phosphine oxide initiator of claim 21, wherein the n+m-valent moiety M is an aliphatic moiety comprising 1 to 10 carbon atoms.

24. The acyl phosphine oxide initiator of claim 21, wherein the acyl phosphine oxide initiator is selected from the group consisting of:

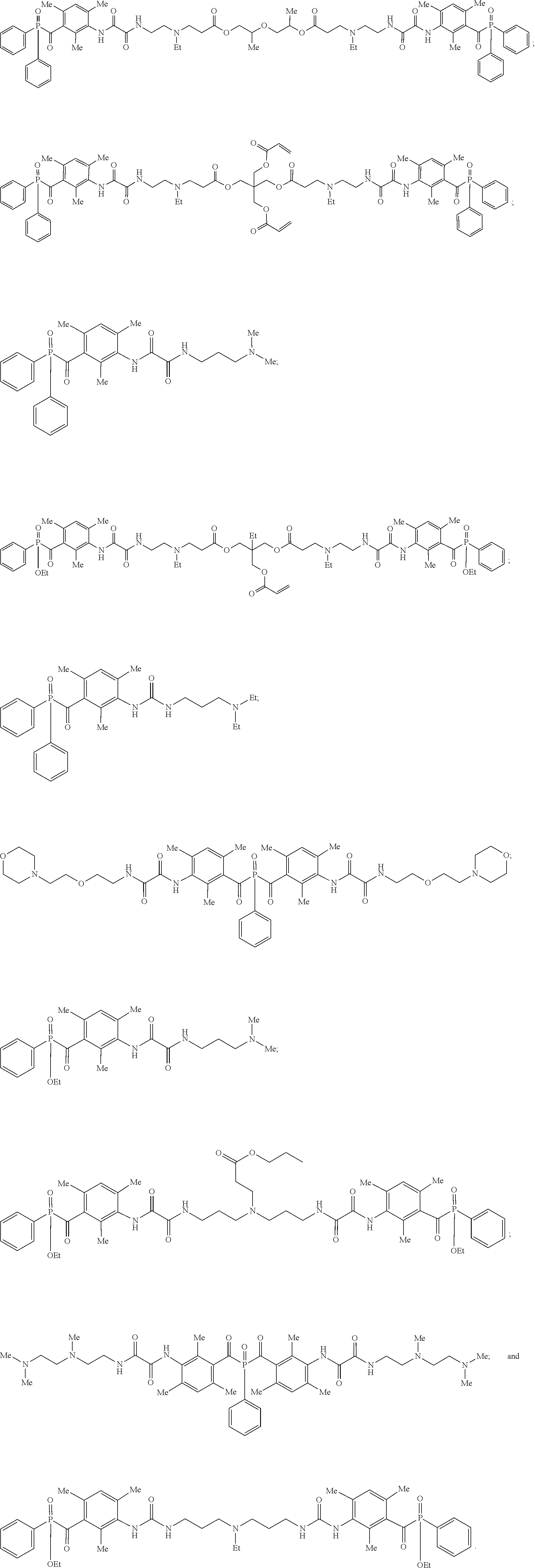

25. The acyl phosphine oxide initiator of claim 16, obtained by the synthesis scheme: 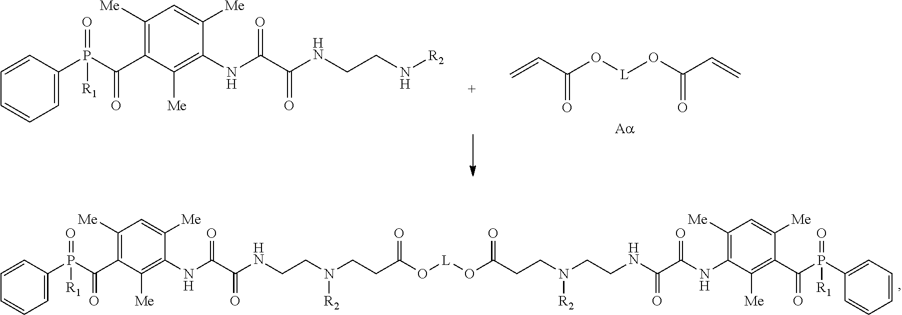
wherein R₁ is OEt or phenyl; R₂ is a C₁ to C₈ alkyl group; and L is a divalent linking group having no more than 20 carbon atoms being not further functionalized with acrylates; and wherein the difunctional acrylate Acr is selected from the compounds Acr-1 to Acr-15:

| | |
|---|---|
| | Acr-1 |
| | Acr-2 |
| | Acr-3 |
| 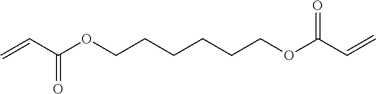 [SMILES: C=CC(=O)OCCCCCCOC(=O)C=C] | Acr-4 |
| 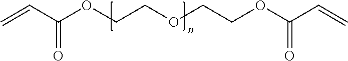 | Acr-5 |
| n = 4 on average | |
| 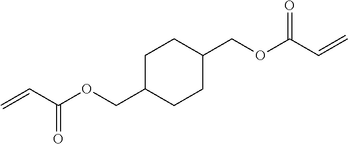 [SMILES: C=CC(=O)OCC1CCC(COC(=O)C=C)CC1] | Acr-6 |
| 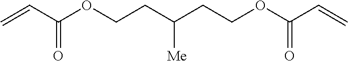 [SMILES: C=CC(=O)OCCC(C)CCOC(=O)C=C] | Acr-7 |
| 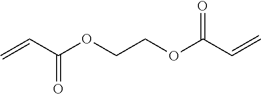 | Acr-8 |
| 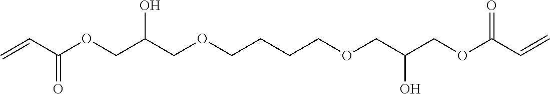 [SMILES: C=CC(=O)OCC(O)COCCCCOCC(O)COC(=O)C=C] | Acr-9 |
| 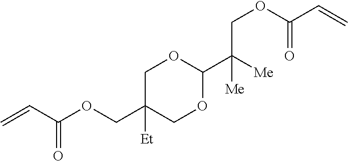 [SMILES: C=CC(=O)OCC1(CC)COC(C(C)(C)COC(=O)C=C)OC1] | Acr-10 |
| 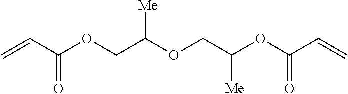 [SMILES: C=CC(=O)OCC(C)OCC(C)OC(=O)C=C] | Acr-11 |
| 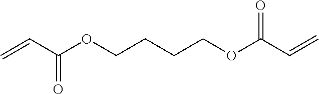 | Acr-12 |
| 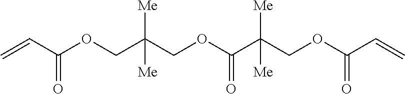 [SMILES: C=CC(=O)OCC(C)(C)COC(=O)C(C)(C)COC(=O)C=C] | Acr-13 |
| 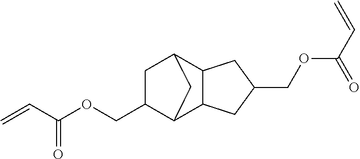 [SMILES: C=CC(=O)OCC1CC2C3CC(COC(=O)C=C)C(C3)C2C1] | Acr-14 |
| 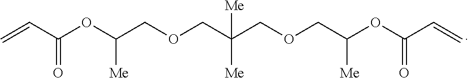 [SMILES: C=CC(=O)OC(C)COCC(C)(C)COCC(C)OC(=O)C=C ; "."] | Acr-15 |

26. The acyl phosphine oxide initiator of claim 25, wherein R₂ is a C₁ to an ethyl or a methyl group.

27. A radiation curable composition comprising a free radical polymerizable compound and an acyl phosphine oxide initiator according to claim 16.

28. A method of preparing an acyl phosphine oxide initiator according to the synthesis scheme: 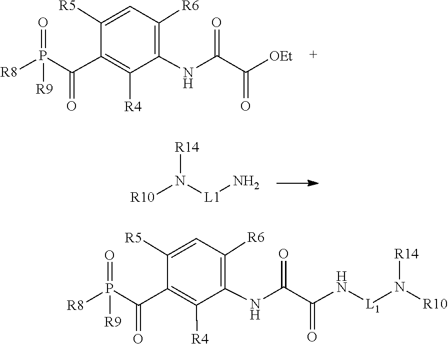
wherein
R4, R5, and R6 are independently selected from the group consisting of hydrogen, a methyl group, and a methoxy group;
R8 is selected from the group consisting of a substituted or unsubstituted aryl group, a substituted or unsubstituted heteroaryl group, and OR12;
R9 is selected from the group consisting of a substituted or unsubstituted aryl group, a substituted or unsubstituted heteroaryl group, and an acyl group;
R10 and R14 each independently represent a substituted or unsubstituted alkyl group;
R12 is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group and a substituted or unsubstituted aryl or heteroaryl group; and
L1 is a substituted or unsubstituted C2 to C6 alkylene group.

29. A method of preparing an acyl phosphine oxide initiator including the steps: 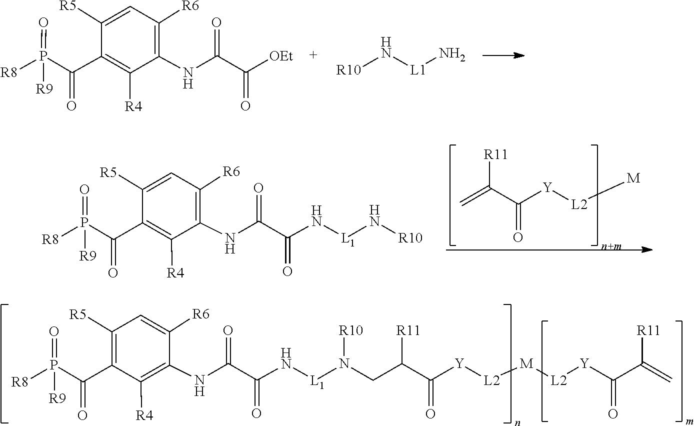
wherein
R4, R5, and R6 are independently selected from the group consisting of hydrogen, a methyl group, and a methoxy group;
R8 is selected from the group consisting of a substituted or unsubstituted aryl group, a substituted or unsubstituted heteroaryl group, and OR12;
R9 is selected from the group consisting of a substituted or unsubstituted aryl group, a substituted or unsubstituted heteroaryl group, and an acyl group;
R10 is a substituted or unsubstituted alkyl group;
R11 is selected from the group consisting of a hydrogen and a methyl group;
Y is selected from the group consisting of an oxygen and NR13;
R12 and R13 are each independently selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group;
L1 is a substituted or unsubstituted C₂ to C₆ alkylene group;
L2 is a divalent linking group comprising no more than 10 carbon atoms;
n is an integer 1 or 2;
m is an integer from 0 to 3; and
M is hydrogen if m=0; a covalent bond if n=m=1 or an n+m-valent moiety if n>1 and m>0.

30. The method of claim 29, wherein the reactant represented by formula 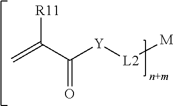
is selected from the group consisting of poly(ethylene glycol) diacrylate, dipropylene glycol diacrylate, tripropylene glycol diacrylate, pentaerythritol triacrylate and ethoxylated or propoxylated derivatives thereof, trimethylol propane triacrylate and ethoxylated and propoxylated derivatives thereof, dipentaerythritol penta-acrylate and ethoxylated and propoxylated derivatives thereof, neopentyl glycol diacrylate and ethoxylated and propoxylated derivatives thereof, dipentaerythritol hexa-acrylate and ethoxylated and propoxylated derivatives thereof, glycerol triacrylate and ethoxylated and propoxylated derivatives thereof, ditrimethylolpropane tetraacrylate and ethoxylated and propoxylated derivatives thereof, hexamethylene diacrylate and ethoxylated and propoxylated derivatives thereof, neopentylglycol hydroxypivalate diacrylate, tricyclodecanedimethanol diacrylate, and 3-methyl-1,5-pentanediyl diacrylate.

31. A method of preparing an acyl phosphine oxide initiator according to the synthesis scheme: 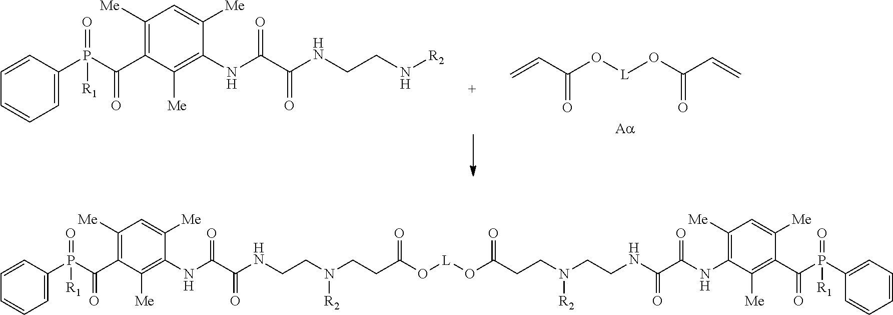
wherein R₁ is OEt or phenyl; R₂ is a C₁ to C₈ alkyl group; and L is a divalent linking group having no more than 20 carbon atoms being not further functionalized with acrylates; and wherein the difunctional acrylate Acr is selected from the compounds Acr-1 to Acr-15:

| | |
|---|---|
| 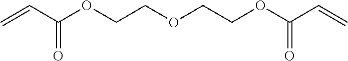 | Acr-1 |
| 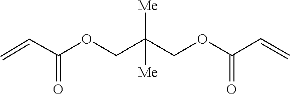 | Acr-2 |
| 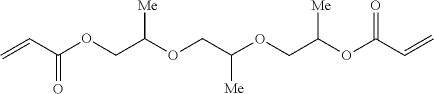 [SMILES: C=CC(=O)OCC(C)OCC(C)OCC(C)OC(=O)C=C] | Acr-3 |
| 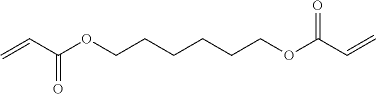 [SMILES: C=CC(=O)OCCCCCCOC(=O)C=C] | Acr-4 |
| 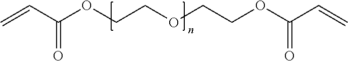 | Acr-5 |
| n = 4 on average | |
| 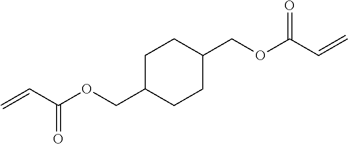 [SMILES: C=CC(=O)OCC1CCC(COC(=O)C=C)CC1] | Acr-6 |
| 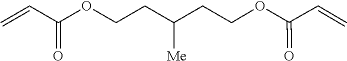 [SMILES: C=CC(=O)OCCC(C)CCOC(=O)C=C] | Acr-7 |
| 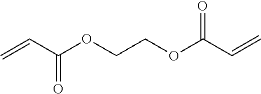 | Acr-8 |
| 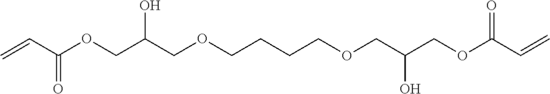 [SMILES: C=CC(=O)OCC(O)COCCCCOCC(O)COC(=O)C=C] | Acr-9 |
| 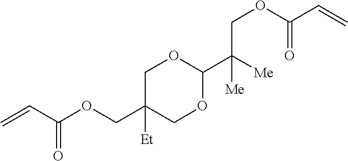 [SMILES: C=CC(=O)OCC1(CC)COC(C(C)(C)COC(=O)C=C)OC1] | Acr-10 |
| 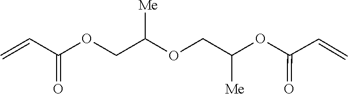 [SMILES: C=CC(=O)OCC(C)OCC(C)OC(=O)C=C] | Acr-11 |
| 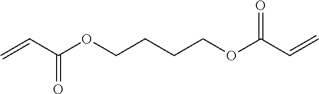 | Acr-12 |
| 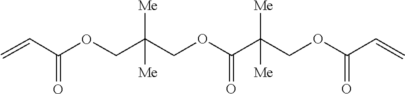 [SMILES: C=CC(=O)OCC(C)(C)COC(=O)C(C)(C)COC(=O)C=C] | Acr-13 |
| 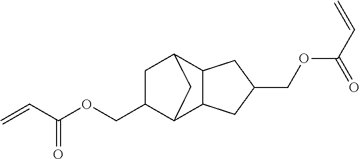 [SMILES: C=CC(=O)OCC1CC2C3CC(COC(=O)C=C)C(C3)C2C1] | Acr-14 |
| 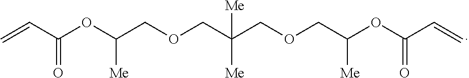 [SMILES: C=CC(=O)OC(C)COCC(C)(C)COCC(C)OC(=O)C=C ; "."] | Acr-15 |

32. The method of preparing an acyl phosphine oxide initiator of claim 31, wherein R₂ is an ethyl or a methyl group.

33. A method for preparing an acyl phosphine oxide initiator including no more than two photoinitiating moieties having a phosphine oxide group and an acyl group selected from the group consisting of a benzoyl group substituted by an urea group or an oxalylamide group; a 2,6-dimethyl benzoyl group substituted in position 3 by an urea group or an oxalylamide group; a 2,6-dimethoxy benzoyl group substituted in position 3 by an urea group or an oxalylamide group; a 2,4,6-trimethyl benzoyl group substituted in position 3 by an urea group or an oxalylamide group; and a 2,4,6-trimethoxybenzoyl group substituted in position 3 by an urea group or an oxalylamide group,
wherein the urea group and the oxalylamide group include a tertiary amine group positioning a phosphorus atom of the acylphosphine oxide initiator in a 1 to Z position, where position 1 is defined as that of the phosphorus atom and position Z is defined as the nitrogen atom of the tertiary amine group with Z representing an integer selected from 11 to 16,
using an intermediate represented by Formula IV: 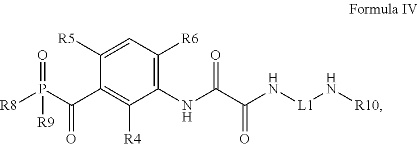
wherein
R4, R5, and R6 are independently selected from the group consisting of hydrogen, a methyl group, and a methoxy group;
R8 is selected from the group consisting of a substituted or unsubstituted aryl group, a substituted or unsubstituted heteroaryl group, and OR12;
R9 is selected from the group consisting of a substituted or unsubstituted aryl group, a substituted or unsubstituted heteroaryl group, and an acyl group;
R10 is a substituted or unsubstituted alkyl group;
R12 is selected from the group consisting of hydrogen, a substituted or unsubstituted alkyl group, a substituted or unsubstituted alkenyl group, a substituted or unsubstituted alkynyl group, a substituted or unsubstituted aralkyl group, a substituted or unsubstituted alkaryl group, and a substituted or unsubstituted aryl or heteroaryl group; and
L1 is a substituted or unsubstituted C₂ to C₆ alkylene group.
